(19) United States
(12) Patent Application Publication
(10) Pub. No.: US 2007/0030582 A1
(43) Pub. Date: Feb. 8, 2007

(54) OVAL ELLIPTICAL MIRROR WITH ORIENTATION LINE

(76) Inventor: William P. Schmidt, Newport, MI (US)

Correspondence Address: ARTZ & ARTZ, P.C., 28333 TELEGRAPH RD., SUITE 250, SOUTHFIELD, MI, 48034, US

(21) Appl. No.: 11/161,419

(22) Filed: Aug. 2, 2005

(51) Int. Cl. G02B 26/08; G02B 5/10

(52) U.S. Cl. 359/868; 359/197

(57) ABSTRACT

A mirror for school buses and other vehicles, preferably a crossover or cross-view mirror. The mirror has an orientation line on its surface, which is oriented horizontal relative to the eyes of the driver of the vehicle. The mirror is preferably an oval elliptical mirror and at least a portion of the top portion of the mirror above the orientation line has a reduced glare or anti-glare surface.

### TECHNICAL FIELD

The present invention relates to mirrors for school buses and other vehicles, particularly cross-view mirrors for school buses.

### BACKGROUND OF THE INVENTION

It is the known to provide school buses with mirrors mounted on the front fenders to provide wide-angle fields of view and to enable the bus driver to monitor activity along the front and sides of the buses. These mirrors are called “cross-view” mirrors or “cross-over” mirrors and afford the bus drivers visual access in front of the school buses, as well as alongside the buses, which are hidden from direct view. Crossover mirrors and mirror assemblies have been deployed on school buses and are, in fact, required by federal and local regulations. Mirrors of this type are shown, for example, in U.S. Pat. No. 4,436,372.

The crossover mirrors can be provided in a variety of sizes and shapes such as oval or spherical. Many are dome-shaped in order to achieve a wider field of view. When oval-elliptical crossover mirrors are provided, it is often difficult to accurately position them in order to provide the optimum field of view for the vehicle driver.

It is thus an object of the present invention to provide an improved crossover mirror for use on school buses and other vehicles. It is another object of the present invention to provide an improved method or system for accurately aligning an oval elliptical crossover mirror in order to provide an optimum field of view for the vehicle driver.

### SUMMARY OF THE INVENTION

In accordance with the present invention, an oval elliptical mirror is provided for mounting on the front fender of a vehicle, such as a school bus, in order to provide a wide field of view, particularly in the front of the vehicle and along the side of the vehicle opposite the driver. An orientation line is provided on the lens of the mirror in such a manner that it provides for proper alignment and positioning of the mirror. When the orientation line is positioned horizontally relative to the front forward field of view of the vehicle driver, the mirror is optimally positioned. The preferred method of alignment comprises aligning the mirror in at least the pitch and roll directions.

The mirror can be attached to the school bus or other vehicle in any known manner but preferably uses a ball-type mounting mechanism.

The surface of the oval elliptical mirror vertically above the orientation line is tinted or otherwise treated to make it anti-glare or anti-reflective.

Other objects, features and benefits of the present invention will become apparent from the following description of the invention, particularly when viewed in accordance with the accompanying drawings and appended claims.

### BRIEF DESCRIPTION OF THE DRAWINGS

FIG. 1 is a schematic view of a pair of crossover mirrors mounted on a school bus.

FIG. 2 is view of a crossover mirror in accordance with the present invention when viewed by the school bus driver inside the vehicle.

FIG. 3 is a front elevational view of a crossover mirror in accordance with the present invention.

FIG. 4 is a side elevational view of the mirror as shown in FIG. 3.

FIG. 5 is another view illustrating the use and alignment of the present invention on a school bus or other vehicle.

FIGS. 6A and 6B illustrate a step in the mounting and alignment of the present invention on a vehicle.

FIGS. 7A and 7B illustrate another step in the mounting and alignment process with respect to the present invention.

FIG. 8 is a schematic view illustrating a possible further alignment of the present invention relative to the driver of the school bus or other vehicle.

FIG. 9 illustrates a further step in the mounting and aligning of a mirror in accordance with the present invention.

FIGS. 10 and 11 illustrate two alternate embodiments for mounting mechanisms used to mount a mirror in accordance with the present invention on a school bus or other vehicle.

FIG. 12 is a flow chart illustrating the basic steps of a preferred embodiment of the present inventive method.

### DESCRIPTION OF THE PREFERRED EMBODIMENT(S)

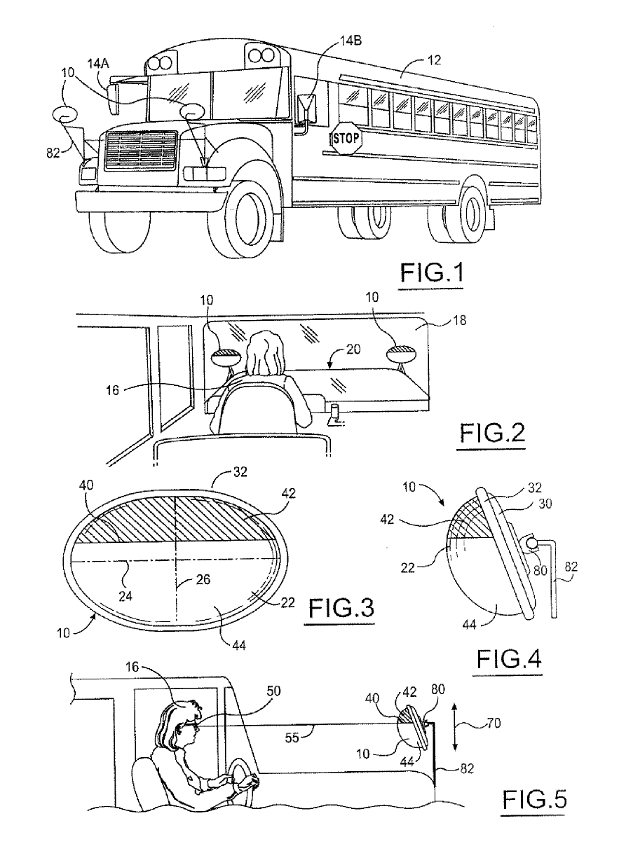

As shown in FIG. 1, the mirrors 10 in accordance with the present invention are preferably positioned on the front fenders of a vehicle such as a school bus 12. Although the present invention is described with reference to being used and positioned on school buses, it is obvious that the present invention can be used on any vehicle, including trucks and vans. As indicated above, cross-view mirrors or crossover mirrors are used in order to enlarge the field of view for a vehicle driver along the front and the sides of the vehicle opposite the driver. These mirrors are provided along with conventional rear view mirrors 14A, 14B which are typically positioned adjacent the windows or sides of the vehicle in order to allow the driver to have a field of view toward the rear of the vehicle.

FIG. 2 schematically illustrates the field of view of a bus driver 16 in accordance with the present invention. As the driver 16 looks out the front window 18 of the bus or other vehicle, the field of view typically includes the hood 20 of the vehicle, along with the crossover mirrors 10.

A preferred mirror assembly in accordance with the present invention is shown in FIGS. 3 and 4. The mirror 10 has an oval elliptical shape with a convex dome-like lens structure 22. The lens of the mirror has an ellipsoid shape and can have a radius of curvature that is either constant along both the major and minor axes 24 and 26, respectively, of the lens, or one with a varying radius of curvature. As to the varying radius of curvature, a mirror can have a radius of curvature, which either increases or decreases as the curvature progresses from the center of the mirror to the outer edge.

The preferred mirror assembly has a reflective surface on the lens and can have a transparent protective coating or acrylic layer on it if desired. The inside of the lens typically has a non-reflective surface. The dome-like lens member 22 of the mirror assembly 10 has a housing or back member 30, which typically is made from a metal or plastic material. A gasket member 32, which typically is made from elastomeric material, is positioned around the outer edge of the material lens 22 and housing 30. The gasket member 32 provides a seal between the two components of the mirror in order to prevent water and other contaminants from entering into the center of the mirror assembly. The lens member 22 also preferably has a peripheral ledge or rim around the outer edge which accommodates gluing or otherwise securing the backing or housing member 30 to the mirror lens adjacent the edge.

Also in accordance with the present invention, the mirror 10 has an orientation reference line 40, which is marked on the lens. The line 40 can also be used to separate the lens into two portions, an upper non-reflective portion 42 and a lower reflective portion 44. The orientation line 40 is positioned vertically above the major axis 24 of the mirror lens.

The non-reflective portion 42 of the mirror lens can be tinted or otherwise treated or prepared in order to reduce glare in any conventional manner. For example, a non-glare coating can be applied to the mirror surface, or a membrane, shield or cover of some type can be positioned covering the portion 42. In general, the top non-reflective portion 42 will have a darker, duller image due to the anti-glare treatment. It is also possible in accordance with the present invention to provide a non-glare or non-reflective surface on only a portion of the upper portion 42.

The orientation line 40 is affixed or applied to the mirror surface in a conventional manner and is similar to a “great circle route” on a globe, or a rhumb line. The orientation line is positioned in a straight line across the surface of the mirror lens, preferably from one edge to the other (as shown). It is also possible for the orientation line to be a discontinuous line or comprise a line or row of small letters or symbols. It is further possible for the orientation line to comprise merely one or more reference marks on the mirror lens suitable for use in orienting and aligning the mirror assembly in the proper manner as set forth below.

As discussed in more detail below, the orientation line 40 is preferably aligned and positioned such that it is positioned horizontally in the eyes of the driver 16 of the vehicle. The orientation line or mark(s) are preferably positioned such that they are parallel to the horizon.

The mirror assembly 10 can be connected or attached to the vehicle 12 in any conventional manner known in the art. However, it is preferred that a ball-type mounting mechanism 80 be utilized, as shown in FIGS. 4 and 10. The mounting mechanism 80 includes a supporting rod 82 as well as other conventional components. Mounting mechanisms of this type are shown, for example, in U.S. Pat. No. 6,227,674, the disclosure of which is hereby incorporated by reference herein. It is also possible to use other mirror mounts in order to attach the inventive mirror 10 to a vehicle 12, such as a tunnel mount. A typical or representative tunnel mount 90 is shown in FIG. 11. The mount 90 includes a supporting rod 92 as well as other conventional components. Tunnel mounts of this type are shown, for example, in U.S. Pat. No. 5,316,257, the disclosure of which is hereby incorporated by reference herein.

Typically, a cross-view mirror is attached to and mounted on a bus or other vehicle utilizing a mounting mechanism comprising several struts and braces. A representative mounting of this type, which can be utilized with the present invention, is shown in FIG. 1 and also disclosed in U.S. Pat. No. 6,227,674, the disclosure of which is hereby incorporated by reference herein.

In order to obtain optimum or maximum performance and field of view from the present invention, it is important to mount the mirror in a certain way on the vehicle and insure that the orientation line 40 is positioned horizontally relative to the eyes of the driver. As shown in FIG. 5, the orientation line 40 of the mirror 10 is preferably positioned such that it is on a substantially parallel position horizontally with the eyes 50 of the driver 16. As shown in FIG. 8, it is also possible, but typically not necessary, to align or adjust the rear plane A of the mirror 10 (as represented by reference plane 52) to be parallel to a reference line or plane B passing through the eyes 50 of the driver 16 of the vehicle (as represented by reference plane 54).

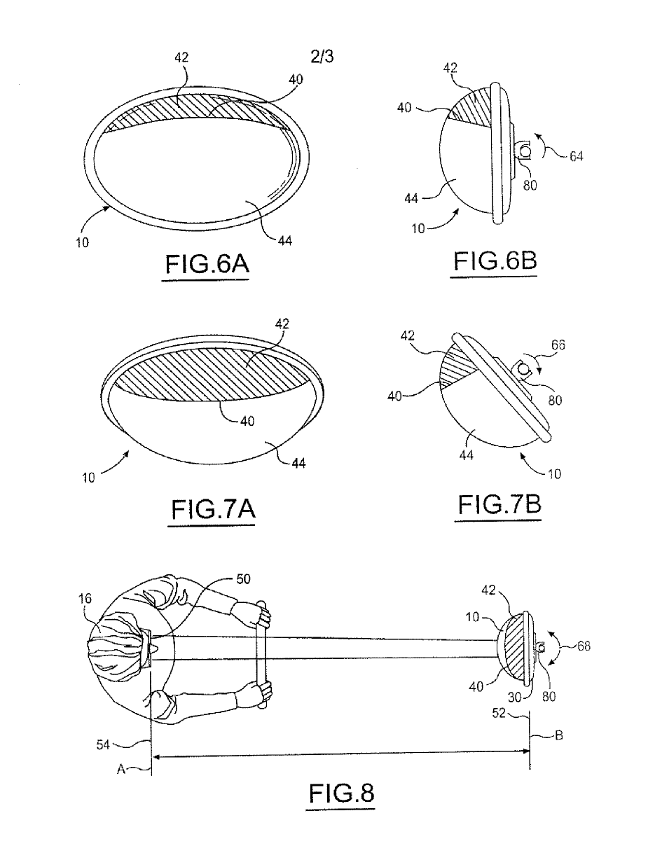

Again, as shown in FIGS. 3 and 4, the orientation line 40 is preferably positioned horizontally relative to the ground in the eyes of the driver. If the mirror 10 is not positioned properly, then the orientation line 40 will not be horizontal. For example, as shown in FIGS. 6A and 6B, if the mirror 10 is not angled sufficiently with respect to the ground, the orientation line 40 would be curved in a convex manner to the driver. Alternately, if the mirror 10 is angled too far relative to the vertical, the orientation line 40 would be curved in a concave manner in the eyes of the driver, as shown in FIGS. 7A and 7B.

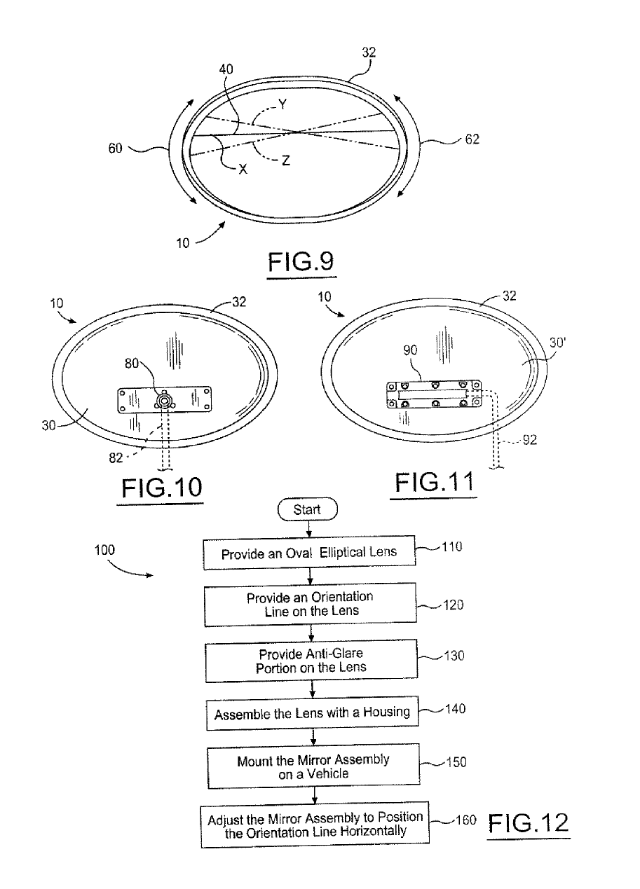

As shown in FIG. 9, if the orientation of the mirror is not precisely positioned for the maximum optimum performance, the orientation line 40 could take the position of lines Y and Z. The preferred orientation of the orientation line 40 is in the horizontal location X as shown in FIG. 9. In order to achieve this alignment or positioning, the mirror 10 is adjusted both visually and manually relative to the mounting mechanism in accordance with the arrows 60 and 62 until the proper orientation is established.

Thus, as shown and described above, the mirror assembly 10 in accordance with the present invention should be orientated and adjusted along at least each of the pitch and roll axes in order to provide the proper position of the orientation line 40 for optimum performance. Once the mirror is positioned on the front of the vehicle and the driver is positioned inside looking out through the front window, the mirror is aligned in the manner of the arrow 64 in FIG. 6B and the arrow 66 in FIG. 7B (i.e. aligned in the pitch direction). The mirror assembly also is aligned in the manner of arrows 60 and 62 in FIG. 9 (i.e. aligned in the roll direction). It is also possible that the mirror assembly be adjusted in the yaw direction, although not necessarily in a parallel relationship as shown in FIG. 8. Manual adjustment in the manner of arrow 68 in FIG. 8 will align the mirror in the yaw direction.

It is also possible to adjust the vertical height of the mirror assembly in accordance with the arrow 70 in FIG. 5. This can allow the field of view from the driver's eyes 50 to the mirror 10 to be substantially horizontal with the ground as well. It is to be noted, however, that adjusting the height of the mirror 10 relative to the ground such that the driver's eyes 50 and orientation line 40 are positioned along a horizontal reference plane or line 55, which is parallel to the ground, is not critical. As a result, when the mirror is orientated and adjusted in the directions shown by the arrows 62, 64 and 66, and possibly arrows 68 and 70, the orientation line 40 should be positioned horizontally and the mirror 10 should have the optimum and preferred field of view in accordance with the present invention. The invention insures that the major axis of the mirror will be aligned horizontally and that the forward tilt of the mirror will be proper for optimum viewing by the vehicle driver.

A preferred embodiment of an inventive method in accordance with the present invention is depicted in FIG. 12. In accordance with the method 100, an oval elliptical lens is provided 110 and an orientation line is provided on the lens 120, which separates the surface of the lens into two portions. An anti-glare material or coating is provided on one portion 130 and the lens is assembled together with a backing member or housing 140. The mirror assembly is then mounted on a vehicle in a conventional manner 150 and the mirror assembly is then adjusted at least in the pitch and roll directions until the orientation line is properly positioned as discussed above 160.

While particular embodiments of the invention have been shown and described, numerous variations and alternative embodiments will occur to those skilled in the arm. Accordingly, it is intended that the invention be limited only in terms of the appended claims.

1. A crossover mirror assembly for a vehicle, the mirror comprising:
a housing member;
an oval elliptical lens member positioned on said housing and having an outer surface;
said lens member having a major axis and a minor axis on said surface; and
an orientation line or mark positioned on said lens member generally separating said outer surface into an upper surface portion and a lower surface portion;
said orientation line or mark being positioned on said lens member such that it can be positioned substantially horizontally relative to the field of view of a driver of a vehicle on which the mirror is mounted;
at least a portion of said upper surface portion being anti-reflective and said lower portion being reflective.

2. A crossover mirror assembly as described in claim 1 wherein said housing member has an oval perimetrical shape.

3. A crossover mirror assembly as described in claim 1 wherein said lens member has an oval outer edge, and said edge is securely connected to said housing member.

4. A crossover mirror assembly as described in claim 1 further comprising a gasket member positioned around the peripheral edges of said lens member and said housing member.

5. A crossover mirror assembly as described in claim 1 wherein said orientation line or mark is positioned on said outer surface above said major axis.

6. A crossover mirror assembly as described in claim 1 wherein the anti-reflective surface comprises an anti-glare coating is provided on at least a portion of said outer surface in said upper surface portion.

7. A crossover mirror assembly as described in claim 1 wherein said lens member has a constant radius of curvature along said major and minor axis.

8. A crossover mirror assembly as described in claim 1 wherein lens member has a varying radius of curvature at least along said major axis.

9. A process for positioning an oval elliptical crossover mirror assembly on a vehicle in an optimum orientation, said steps comprising:
(a) providing an oval elliptical mirror assembly with an outer surface;
(b) providing an orientation line or mark on said mirror assembly separating said outer surface into an upper surface portion and a lower surface portions said orientation line or mark being positioned on said lens member such that it can be positioned substantially horizontally relative to the field of view of a driver of a vehicle on which the mirror assembly is affected;
(c) providing an anti-glare surface at least on a portion of said upper surface portion;
(d) providing a mounting mechanism for mounting said mirror assembly on the vehicle; and
(e) aligning said mirror assembly to position said orientation line or mark substantially horizontally.

10. The process as set forth in claim 9 wherein said step of aligning said mirror assembly comprises aligning said mirror assembly in at least a pitch and roll directions.

11. The process as described in claim 10 further comprising adjusting said mirror assembly in a yaw direction.

12. The process as described in claim 9 wherein said surface of said oval elliptical mirror assembly has a major axis and a minor axis and wherein said orientation line or mark is positioned vertically above said major axis.

13. The process as described in claim 9 wherein said anti-glare surface comprises an anti-reflective coating.

14. A crossover mirror assembly as described in claim 1 wherein said orientation line or mark comprises a line extending substantially across the surface of said lens member.

15. A crossover mirror assembly as described in claim 14 wherein said line is discontinuous.

16. A crossover mirror assembly as described in claim 1 wherein said orientation line or mark comprises a row of letters or symbols.

17. A crossover mirror assembly as described in claim 1 wherein said orientation line or mark comprises a plurality of reference marks.

18. The process as set forth in claim 9 wherein said orientation line or mark is applied to said lens member substantially in a great circle route configuration.

19. A crossover mirror assembly for a vehicle, the mirror comprising:
a housing member,
an oval elliptical lens member positioned on said housing and having an outer surface;
said lens member having a major axis and a minor axis on said surface; and
orientation means positioned on said lens member generally separating said outer surface into an upper surface portion and a lower surface portion;
said orientation means comprising a reference line or plurality of marks applied to said lens member substantially in a great circle route configuration;
at least a portion of said upper surface portion being anti-reflective and said lower portion being reflective.
